(19) United States
(12) Patent Application Publication
(10) Pub. No.: US 2006/0167716 A1
(43) Pub. Date: Jul. 27, 2006

(54) Method of extracting and reporting death information

(76) Inventors: Hugh Z. Graham JR., Columbia, SC (US); William DeB. Mebane, Greenville, SC (US)

Correspondence Address: B. Craig Killough;Barnwell Whaley Patterson & Helms, LLC, P.O. Drawer H, Charleston, SC, 29402-0197, US

(21) Appl. No.: 11/337,203

(22) Filed: Jan. 20, 2006

Related U.S. Application Data
(60) Provisional application No. 60/646,034, filed on Jan. 21, 2005.

(51) Int. Cl. G06Q 99/00

(52) U.S. Cl. 705/1

(57) ABSTRACT

A method of extracting and reporting death information includes monitoring reports of death from various sources, and selectively transmitting extracted data to persons who subscribe with a provider of the method. A database is created of persons whose deaths are to be reported to consumers of the information. The consumer specifies the information and method of transmittal of the desired information. Reports of death are monitored according to the consumer's requirements. The method compares data identifying the reported deceased with data provided by the consumer. When a match is identified, a notice of death and other data are reported to the consumer in the manner specified.

Applicants claim the benefit of Provisional Application Ser. No. 60/646,034filed Jan. 21, 2005.

### BACKGROUND AND SUMMARY OF THE INVENTION

A method of extracting and reporting death information includes monitoring reports of death from various sources and selectively transmitting extracted data to. (consumers) who subscribe with a provider of the method. A database of persons whose deaths are to be reported to consumers is created.

The consumer specifies the information and method of transmittal of the desired information. Reports of death are monitored according to the consumer's. The method compares data identifying the reported deceased with data defined by the consumer. When a match is identified, notice is reported to the consumer in the manner specified. Clients may be consumers such as attorneys in possession of estate documents, affected bank trust departments, independent trustees, banks monitoring depositor activities, and similar interested persons or entities, which are able to take action based upon the information, which is received relatively contemporaneously with the subject person's death.

### DESCRIPTION OF THE DRAWINGS

100 The Client Interface

This drawing shows the client or consumer interface to the proposed application and includes the web-based marketing presentation and the various selected security levels. The drawing also shows how the consumer can access both the rules and the list management modules through the password protected interface.

200 The Preliminary Search Process

This drawing shows how lists are aggregated together into larger search criteria. That search criteria has proprietary parsing rules applied to it to speed up the search from external databases. The drawing also demonstrates how the parsing system interfaces with the various outside databases.

290 The Match Confirmation Process

This drawing defines the steps and pathways required to take a preliminary “match” through confirmation of all required data fields in order to provide consumer with the correct match. Once again, the system uses vendor-generated rules technology to access vendor databases with looking for complete record match. If successful, the match is communicated to the consumer.

400 The Client Notification System

This drawing shows how confirmed matches automatically access client or consumer generated rules for distribution to the consumer through completely secure distribution tools, many of which require user (consumer) side passwords or decryption devices in order to access the records transmitted.

### DESCRIPTION OF THE PREFERRED EMBODIMENTS

100 The Client Interface

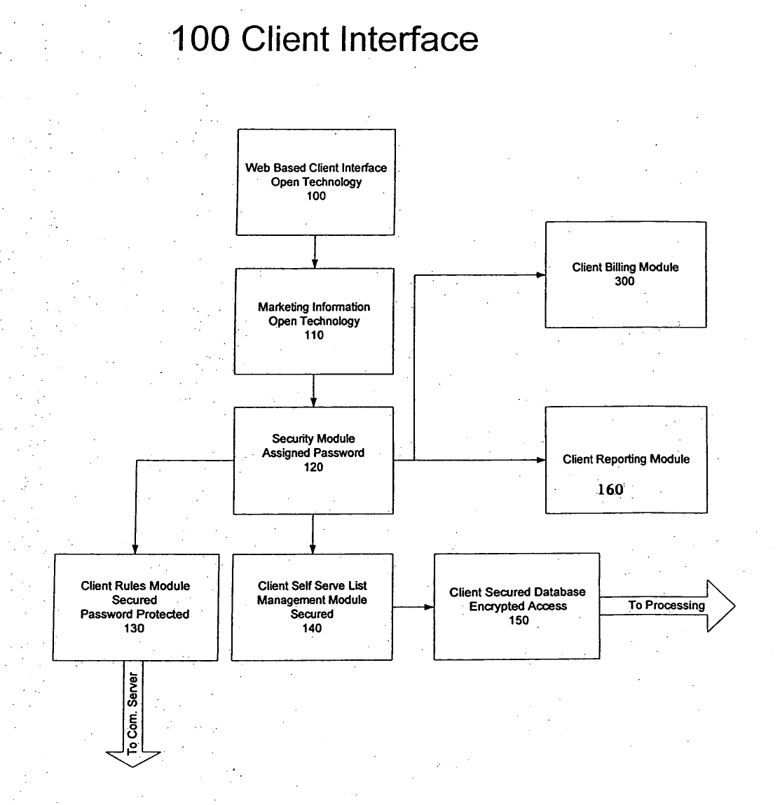

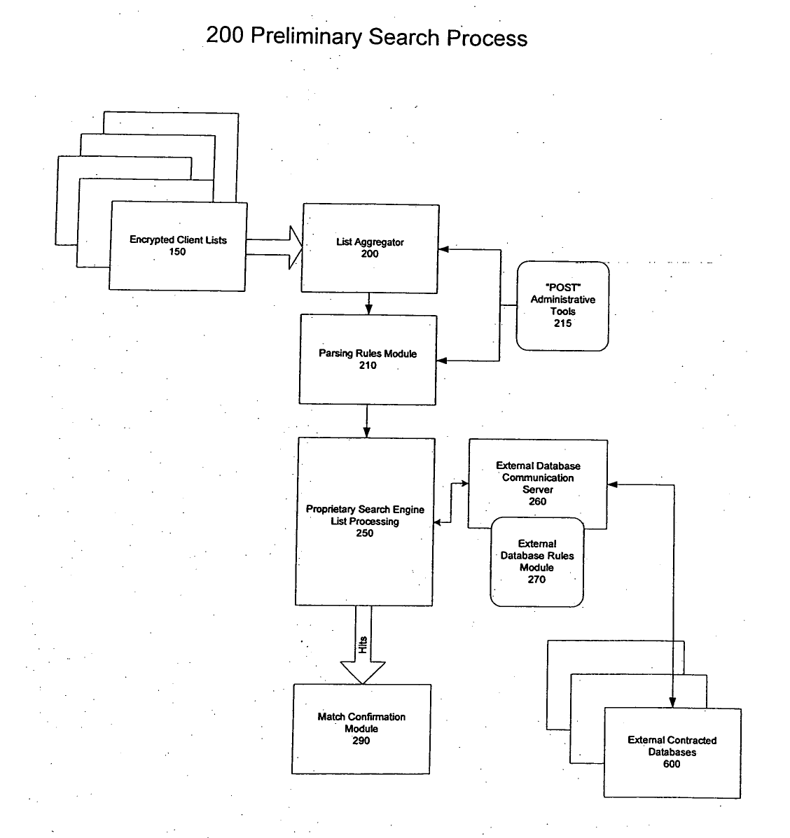

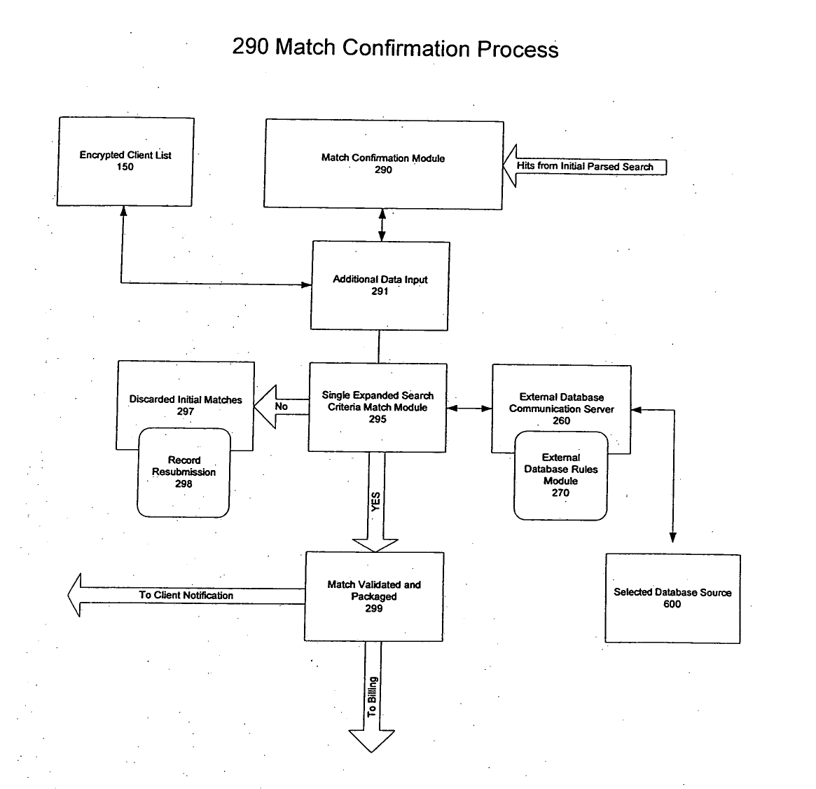

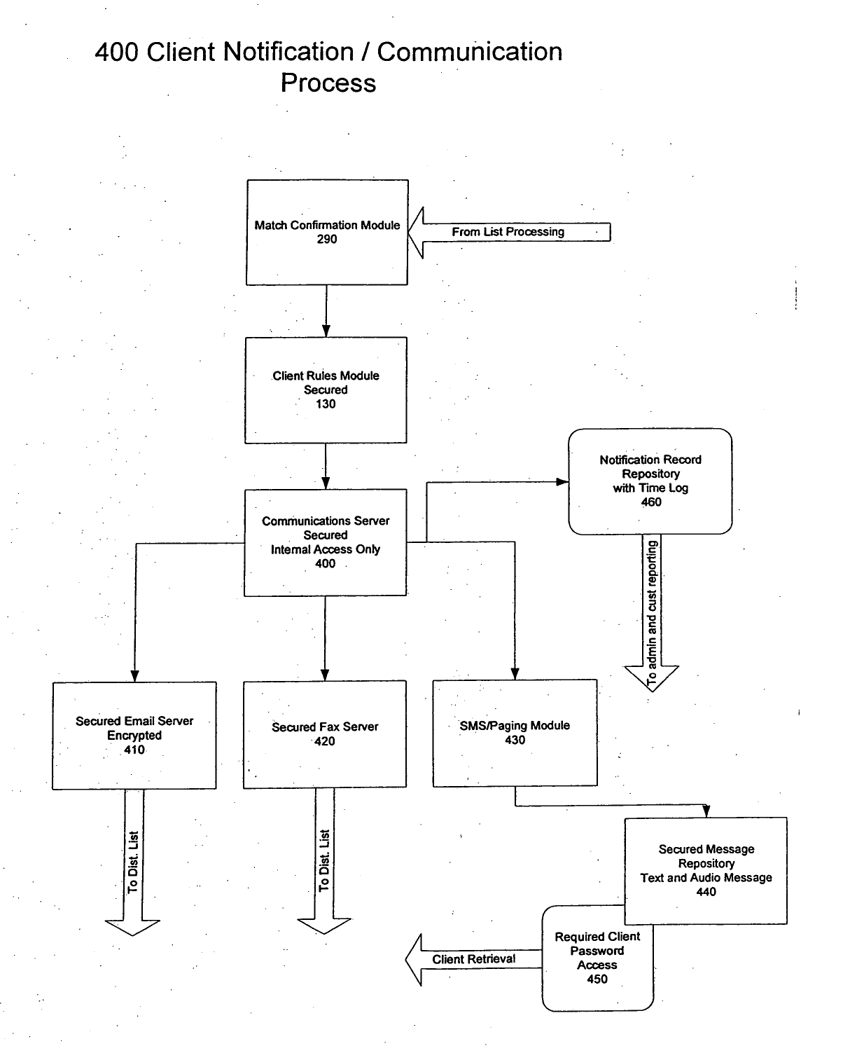

FIG. 100 defines preferred basic application modules selected by the consumer or operator and employed by the invention to manage the interaction with the system.

Any client or consumer can access the application through any internet browser capable of displaying HTML. The consumer or other user enters designated web addresses into browsers or follows links from other marketing-based exposures to find the application home page on the internet.

The home page and all consumer accessible internet pages reside on the web server (100). Consumers accessing the home page have the option to review the marketing and sales materials for additional information about the service (110), or to or proceed directly to the consumer maintenance and management screens.

Consumers in the marketing environment are advised of the ability to purchase the service, secure passwords and begin uploading their proprietary lists into the application for daily nationwide searches. Those who choose to purchase the service select payment options and define consumer specific password within the Security Module (120). Once payment options have been selected, the consumer billing module (300) handles the various billing and payment options automatically. Once the consumer has committed to a purchase, the user consumer selects a security-based user name and password. Consumers input user identifiers and passwords to access all consumer maintenance and management levels of the application.

Consumers with accepted passwords select from three options: 1. Consumer Rules and Instructions, which sets the individual level of security, adds additional levels of security if required, and accepts instructions regarding who is to be contacted if a match is registered. For each contact, the administrative password may select the method of contact and security level to access contact data. 2. The List Management Module where users input their desired contact screens (lists) selecting which fields and levels of information they wish to confirm before a confirmation notification is sent. 3. Reports on activity relating to specific lists of the consumer, upon demand.

Once consumers have approved their list input and search criteria in the List Management Module, they “import” the list into a secured and encrypted database in fields dedicated exclusively to that specific customer.

The List Management Module also provides customers the opportunity to modify list names, add search criteria, delete names or add names.

The Client (consumer) Reporting Module (160) provides consumers with the opportunity to run reports on any topic from all searches run to specific searches. Consumers may review searches by day to ascertain the number of preliminary hits against the number of completed matches by individually defined criteria.

200 The Preliminary Search Process

The preliminary search process (200) provides high speed searching through millions of outside records searching initially for “likely” matches.

Initially, all lists in the application (150) are aggregated in a proprietary list aggregation process (200). This process combines all like names into categories for easier parsing while at the same time protecting the secure integrity of each name and its related data.

The aggregated lists are further refined in the Parsing Rules Module (210) where additional levels of custom parsing information and search criteria are attached to the search request and searched through each selected remote database. Rules for the parsing process are input through the administrative module (215).

The completed list with all the parsing rules and search criteria is delivered to the Internal Search Engine (250) which processes the search request in according the search capability obtained from each vendor.

The proprietary search engine (250) communicates through high speed data lines managed by an external communication server (260). This communication server (260) manages the specific communication rules required by each remote database proprietor through an External Rules Module (270,) which contains the communication protocols, the password for each vendor database, search rules or limitations imposed by the respective vendors, and the search or access billing information, if required by a specific vendor. The propriety search engine also provides security between the search engine and the database interface, so that the remote database cannot monitor the names that are being searched through the database. This feature is important to, for example, banks that need to maintain customer anonymity.

Once the preliminary search request is properly packaged, it is delivered electronically to each of the specific vendor databases (600). The databases that are searched include multiple daily newspapers. Obituaries, such as those published in newspapers, are available on newspaper websites, and may. be searched via the Internet. Commercial databases, such as Lexis-Nexis, provide access to large numbers of newspapers in a single database. The use of one or more commercial databases may provide increased search efficiency over searching hundreds of individual websites. The commercial database(s) may be supplemented with individual newspaper websites for newspapers that are not available in the commercial database(s). Additionally, or supplementally, individual funeral home websites may be searched. Further, information from governmental departments of vital statistics that issue death certificates, or similar governmental agencies, may be searched, although this information is generally less contemporaneous with the date of death than is information from newspapers and funeral homes.

If the search request does not provide any preliminary “hits”, the search engine simply records the time and accuracy of the search and holds the search request for daily modifications or another run against the vendor data the following day.

Any search request that comes back positive through this initial parse is immediately delivered to the Match Confirmation Module (290) with information on where the initial match came from for additional, much more detailed searching against selected vendor databases.

Individual consumer lists remain in the List Aggregator (200) until the user makes some type of modification to the list, or a confirmed match is generated from the list, at which point in time the list is re-compiled without the previously confirmed match. The search is periodic and repetitive, and is preferred to be performed daily. The database is amended as matches occur, or as the consumer adds or deletes names from the lists, but the search is performed automatically at an appointed time on a daily basis.

In one embodiment, the preliminary search looks for the surnames, first names and middle names or initials of the targeted deceased subjects that are present on the list. Names that match may be provided to the customer for further verification by the customer outside of the process of the invention, or further confirmation may be sought by means of the process to verify that the desired target is the same individual that is a potential match and discovered during the preliminary search process.

290 The Match Confirmation Process

When a potential match is discovered, the search engine sends the match to the Match Confirmation Module (290). Here the record is “repackaged into a single search request with significantly more data required for a complete match. The process starts when the Match Confirmation Module (“MCM”) passes the empty “full request” to the automated data expansion process (291).

When the MCM (290) has an empty record, it reads the identification tag and goes back to the appropriate database (list) to compile all the data the consumer originally entered into the record regarding this potential target. The fields not used in the major parsed search are now filled in completely with identification as to which fields are required for a positive match.

This newly expanded record moves to the Single Search Match Module (295) where it is re-packaged and re-submitted to the vendor database from which the original preliminary match was secured. This re-submission process uses the same external database communications server as the parsing search engine (260), such as Lexis-Nexis, newspapers, funeral homes, and government records.

The dedicated search is run within the selected vendor database (600) based on any required rules supplied by the rules module (270). The results of the single record search are read by the Single Expanded Search Engine (295).

This automated analysis compares required fields in the original record with information from the dedicated search. The additional fields may include information regarding state, then city, then street address of the subject. Other fields may include the birth year and month and day of birth. If enough matches are made (as identified by the consumer in the sign up process), the record is validated and packaged for consumer delivery (299). If the record does not have the required matches, it moves into a discard database (297) where subsequent searches can be run in the vendor databases as more information is scanned into the vendor database. After seven (7) days, the record is erased.

The single expanded search engine (295) is preferred to have internal logic built into it and is a “smart system” where it learns how to compare records efficiently and how to make value judgments as to the quality of the initial match. This “smart” logic increases the overall reliability of the entire application.

Records that are a definite match are transferred with all data in the search criteria to the consumer notification module. This process also triggers an internal record release option where the consumer upon confirming that this is a record that matches the user's list, can eliminate with one click (and a password) that entire record from the user's database list.

Records of this entire process, including the time it took to validate the initial search, are all moved into the consumer recording module where the consumer can see activity. A completed record/consumer notification is also sent to the consumer billing module in case the customer has selected a pay-for-notice type of program.

400 Client Notification Process

Once a record has a positive match, the Match Confirmation Module (290) accesses the Client (consumer) Rules Module (130) to determine how the consumer wants the record packaged for distribution, the method of distribution, and the specific individuals on the customer's secured distribution list. This information, along with any required security access codes or passwords, is sent directly to the Communications Server (400)

The communication server reads the record file and delivers the record in all of the user's specified formats with all the user's specified security.

Consumers requesting e-mail are sent a secured e-mail informing (410) the user of a time-sensitive message from the service provider, and requesting the consumer to click on a specific link. The link takes the consumer to a page where a password is entered, and the full e-mail file is revealed.

Consumers requesting fax notification faxes (420) are sent directly to secured fax numbers as designated by the customer.

Consumers requesting SMS or Cell Notification are contacted at consumer submitted phone numbers (430) and asked to enter their password (all numerical). Upon verification (450), SMS customers see the complete file on their cellular screen. Cell or Phone customers hear a computer recorded message (440) telling them who the file identifies, and directing them how to receive more detailed information by computer or fax.

Once the matched record enters the consumer notification process, all internal processes are timed so the customer can have both escalating levels of contact (urgency) as well as being able to run reports that demonstrate that the system is notifying required parties in a timely fashion.

All records sent through consumer notification are stored in the notification repository (460) as part of the customer file. The records remain in this repository for as long as the customer remains active.

What is claimed is:

1. A method of extracting and reporting information on the death of a person, comprising the steps of:
creating a consumer database comprising a plurality of names of persons;
searching said plurality of names of persons through a plurality of remote databases by means of a computer network, wherein said plurality of remote databases comprises a plurality of newspaper obituary databases;
identifying a matched name by matching a name that is present in said plurality of names of persons with a name that is present in one of said plurality of remote databases; and
notifying a consumer of said matched name by means of said computer network.

2. A method of extracting and reporting information on the death of a person as described in claim 1, wherein said consumer database comprises additional information uniquely associated with each name that is represented in said plurality of names of persons; and comprising the additional steps of:
comparing said additional information that is present in said consumer data base for said matched name with additional information that is associated with said matched name and is present in said one of said plurality of remote databases; and
creating a matched record upon matching said additional information that is present in said consumer data base and is uniquely associated with said matched name with said additional information associated with said matched name that is present in said one of said plurality of remote databases.

3. A method of extracting and reporting information on the death of a person as described in claim 1, wherein each name in said plurality of names of persons comprises a first name, a surname, and at least a first letter of a middle name.

4. A method of extracting and reporting information on the death of a person as described in claim 2, wherein said additional information uniquely associated with each name comprises a city and state of residence.

5. A method of extracting and reporting information on the death of a person as described in claim 2, wherein said additional information uniquely associated with each name comprises a birth date.

6. A method of extracting and reporting information on the death of a person as described in claim 1, wherein searching at least a portion of said plurality of names of persons through said plurality of remote databases by means of said computer network occurs automatically on a periodic and repetitive basis.

7. A method of extracting and reporting information on the death of a person as described in claim 1, wherein searching said at least a portion of said plurality of names of persons through said plurality of remote databases by means of said computer network occurs automatically on a daily basis and is repeated daily.

8. A method of extracting and reporting information on the death of a person as described in claim 1, wherein said plurality of remote databases further comprises information from a plurality of funeral home websites.

9. A method of extracting and reporting information on the death of a person as described in claim 1, further comprising security at an interface between said remote databases and said plurality of names of persons to prevent said remote databases from capturing said plurality of names of persons.
